(19) United States
(12) Patent Application Publication
(10) Pub. No.: US 2009/0248480 A1
(43) Pub. Date: Oct. 1, 2009

(54) CONTROLLED SYNCHRONIZATION BETWEEN A GROUP CALENDAR AND INDIVIDUAL WORK CALENDARS

(76) Inventor: Jan Thomas Miksovsky, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/059,871

(22) Filed: Mar. 31, 2008

(51) Int. Cl. G06F 15/02

(52) U.S. Cl. 705/9

(57) ABSTRACT

Controlled synchronization between one type of calendar and another type of calendar is provided. A family's calendar maintained and stored with a Web-based calendar service server is synchronized with a work calendar(s) of one (or more) of the family's members and vice versa. A user is allowed to define rules for synchronizing appointments between work and family calendars that, by default, automatically produce results consistent with user expectations. Calendar information is filtered based on the synchronization rules for controlling which appointments need to be synced. In an aspect, users can establish a rule to automatically synchronize new work appointments to the user's family calendar if the new work appointment falls outside of the user's normal working hours.

### BACKGROUND

People often compartmentalize the various aspects of their schedules by maintaining multiple computer-based calendars, often within different software products and services. For example, working professionals may maintain work schedules in an office-oriented calendar such as Microsoft® Office Outlook calendar, and their family's calendar in a family-oriented calendar web service.

Despite the general benefit of compartmentalizing one's schedule into work- and family-oriented calendars, there are nevertheless many situations in which an appointment in one calendar is relevant in another. If a user has a work appointment that lies outside of his/her normal working hours (a late meeting, for example), that appointment may be of interest to the entire family of the user. Conversely, if a user has a commitment on a family calendar (a parent-teacher conference) that overlaps or lies within his/her normal work hours, some of the co-workers of the user may need to know since the user will be absent from the office for that period.

Conventionally, a wide variety of tools or applications have been used for synchronizing appointments between different types of calendars, for example, a work calendar and a personal calendar. These tools generally synchronize all appointments in the relevant calendars. For example, an office worker who synchronizes his/her work calendar and his/her family calendar will see in both calendars all their work appointments and all their family appointments. Such uncontrolled synchronization creates problems. In particular, it is not desirable if information regarding the user's private family life is revealed to people other than family. Conversely, it is not desirable if some information regarding business appointments that may be confidential or irrelevant is viewed or accessed by the family members

Some conventional calendars allow only a subset of appointments in a calendar to be synchronized. In this approach, the user is required to manually indicate which appointments need to be synchronized. For example, calendar products such as Microsoft® Office Outlook let the user manually tag an appointment with a predefined category and let the user indicate which category to be used for synchronization.

The main disadvantages of this approach may be that the user is responsible for synchronization. The user may forget to tag a new appointment with an appropriate category or tag the new appointment with a wrong category. As a result, some appointments may not be synchronized to their family calendar. If, for example, a user fails to tag a work calendar appointment for an upcoming business trip with an appropriate category, the family may not become aware of the trip in time to make appropriate arrangements.

Moreover, each user is generally interested in synchronizing family calendar appointments which they specifically need to be aware of (or for which they have some responsibility). To achieve this result, the user can create a categorization scheme in which a separate category exists for each family member. They can then tag a family appointment with the category (or categories) for the family member(s) who must attend, or are responsible for, that appointment. They can then indicate to the synchronization tool which appointment categories they are interested in syncing, and select only the category corresponding to their own appointments. This arrangement is possible, but users need to work it out for themselves, and it is somewhat cumbersome to set up.

### SUMMARY

A method and system is provided for synchronizing two different types of calendars such as a personal (private) calendar and a work calendar. In certain embodiments, the method and system may synchronize a family's calendar maintained and stored with a Web-based calendar service server with a work calendar(s) of one (or more) of the family's members and vice versa. More specifically, the method and system filter calendar information for controlling which appointments need to be synced between the family calendar and a personal work calendar.

In one embodiment, a method for synchronizing a first calendar with a second calendar, wherein the first calendar is shared by a group of users and the second calendar is an individual work calendar of a user, is provided. The method includes obtaining appointments stored with the second calendar, obtaining a set of conditions for a synchronization process of the second calendar and identifying, from the obtained appointments, appointments that have been newly added, updated, or deleted. The identified appointments are filtered based on the set of conditions and the first calendar is updated in accordance with the result of filtering. In one aspect, the method marks a family appointment with the user name indicating that that appointment is associated with the user. Family appointments associated with the user name will be synchronized to the first calendar, for example the work calendar of the user.

In an another embodiment, a method for synchronizing a first calendar with a second calendar, wherein the first calendar is an individual work calendar of a user and the second calendar is shared by a group of users, is provided. The method includes obtaining a user name and a set of rules defined for the user in the second calendar, obtaining appointments stored with the second calendar and detecting changes in the obtained appointments. Upon detecting any changes, appointments that are to be synchronized to the first calendar are identified based on the set of rules. The first calendar is updated with the identified appointments. In an aspect, users can establish a rule to automatically synchronize new work appointments to the family calendar if the new work appointment falls outside of the user's normal working hours.

In one embodiment, a synchronization engine (synchronization component) may be provided to a user device. Through the synchronization engine, the user can establish various aspects of synchronization, including creation of a rule(s) for automatic synchronization between two different types of calendars. For example, the synchronization engine allows a user to define rules for synchronizing appointments between work and family calendars that, by default, automatically produce results consistent with user expectations.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 is a block diagram of a network environment for implementing aspects in accordance with various embodiments;

FIGS. 2A-2C are exemplary screen displays in accordance with embodiments of the present invention;

FIG. 3 is a simple block diagram that depicts a relationship between a family calendar and a work calendar of a particular family member;

FIG. 4-6 are exemplary calendars modified during a synchronization process in accordance with embodiments of the present invention;

FIG. 7 is a simple block diagram of a synchronization engine that maintains copies of a family calendar and a work calendar of a user;

FIG. 8 is a flow diagram implementing a synchronization process from a work calendar to a family calendar in accordance with embodiments of the present invention;

FIG. 9 is a flow diagram implementing a synchronization process from a family calendar to a work calendar in accordance with embodiments of the present invention; and

FIG. 10 is a flow diagram implementing a synchronization process when a deleted appointment is detected from the work calendar in accordance with embodiments of the present invention.

### DETAILED DESCRIPTION

A method and system is provided for synchronizing one type of calendar with another type of calendar. More specifically, in certain embodiments, the method and system may synchronize appointments between a family's calendar and a work calendar of each family member. The method and system filter calendar information for controlling which appointments need to be synchronized between the family calendar and a work calendar. In certain aspects, the method and system allow a user to define rules for synchronizing appointments between work and family calendars that, by default, automatically produce results consistent with user expectations.

In one embodiment, group or family calendar information is filtered in order to update an individual work calendar of a user so that relevant family appointments can be shown in the work calendar of the user. The method and system may allow a user to mark a family calendar appointment with the user name to indicate that that appointment is associated with the user. Generally those family appointments that are associated with the user name will be synchronized to a work calendar of the user. Additionally, some appointments can be marked for the entire family, indicating that such appointments are associated with each family member. Such family appointments marked for the entire family are also synchronized to the work calendar of the user.

In another embodiment, individual work calendar information is filtered to update a family calendar so that relevant work appointments of the user can be shown in the family calendar. The method and system also allow a user to indicate a work calendar appointment to be synced to the family calendar. For example, a user can mark a work calendar appointment as a family appointment. The user can also establish a rule that is automatically applied to determine which new appointments are to be marked as a family appointment. In a certain aspect, users can establish a rule to automatically synchronize new work appointments to the family calendar if the start time or the end time of the new work appointment falls outside of the user's normal working hours.

In an aspect, the method and system utilize existing user information that was obtained for work calendars. Conventional work calendars typically allow a user to define their normal working hours. The method and system use this work-hour information to establish a default rule for handling appointments in a work calendar for synchronization to a family calendar. When this rule is employed, if a new appointment on the work calendar extends beyond the user's normal working hours (e.g., the appointment represents a late work meeting, or an extended business trip), the appointment will be automatically marked for synchronization by default. The user can still override the default rule by marking appointments with various tags or removing associated tags from appointments.

The embodiments discussed herein are illustrative of one or more examples of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, the present descriptions and drawings should not be considered in a limiting sense, as it is understood that the present invention is in no way limited to only the embodiments illustrated.

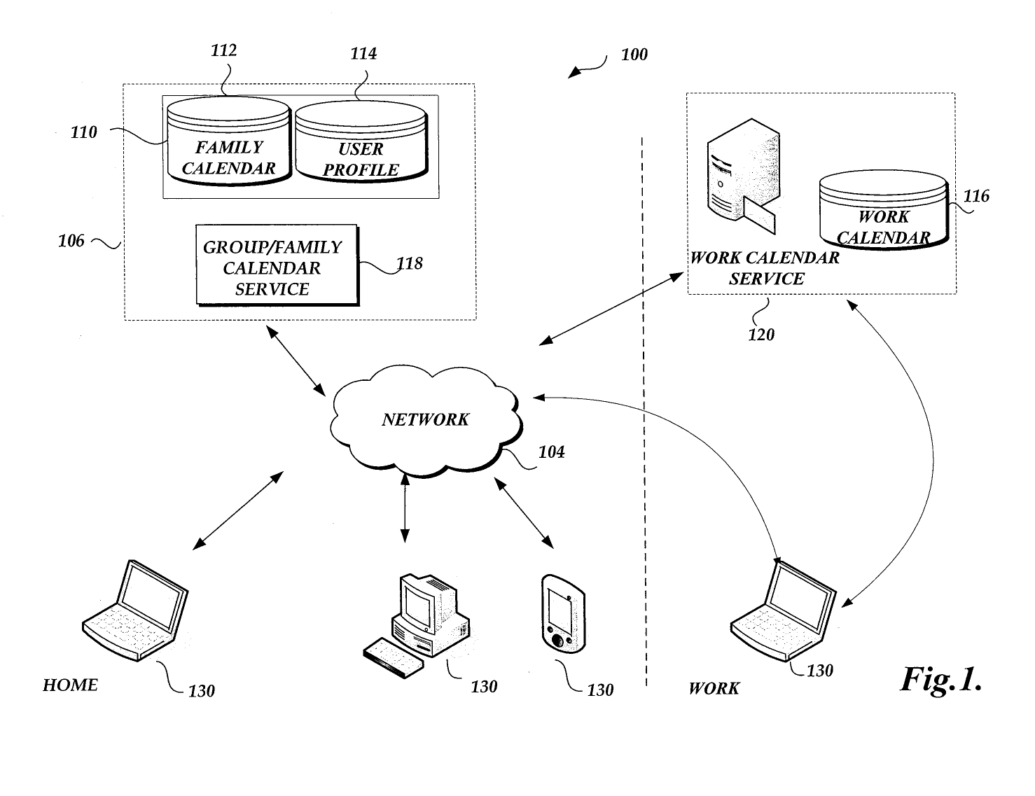

FIG. 1 illustrates an example of an environment 100 for implementing aspects in accordance with various embodiments. As will be appreciated, different environments may be used, as appropriate, to implement various embodiments. The environment 100 shown includes an electronic user device 130, which can include any appropriate device operable to send and receive requests, messages, or information over an appropriate network 104 and convey information back to a user of the device. Examples of such client devices include personal computers, cell phones, handheld messaging devices, laptop computers, personal data assistants, and the like. The network can include any appropriate network, including an intranet, the Internet, a cellular network, a local area network, or any other such network or combination thereof. Protocols and components for communicating via such a network are well known and will not be discussed herein in detail. Communication over the network can be enabled by wired or wireless connections, and combinations thereof. In this example, the network includes the Internet, as the environment includes an online calendar service 106 for receiving requests and serving family calendar appointments in response thereto, although for other networks an alternative device serving a similar purpose could be used as would be apparent to one of ordinary skill in the art.

The environment in one embodiment is a distributed computing environment utilizing several computer systems and components that are interconnected via communication links, using one or more computer networks or direct connections. However, it will be appreciated by those of ordinary skill in the art such a system could operate equally well in a system having fewer or a greater number of components than are illustrated in FIG. 1. Thus, the depiction of the system 100 in FIG. 1 should be taken as being illustrative in nature, and not limiting to the scope of the disclosure.

The illustrative environment further includes at least one application server 118 and a database 110. The application server 118 typically will include an operating system that provides executable program instructions for the general administration and operation of that server, and typically will include a computer-readable medium storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

The database 110 can include several separate data tables, databases, or other data storage mechanisms and media for storing data relating to a particular aspect. For example, the database illustrated includes mechanisms for family calendars 112, user profile information 114, etc. The database 110 is operable, through logic associated therewith, to receive instructions from the application server 118, and obtain, update, or otherwise process data in response thereto.

In one embodiment, the application server 118 is a web-based family calendar service server. The web-based family calendaring service server (hereinafter, family calendar service) provides a calendaring service for a group of users, for example a family, to allow the group of users to stay organized, manage schedules and coordinate with each other. Once registered with the family calendar service, each member of the family can access family information from various places using a user device (e.g., a personal computer, a laptop, a mobile phone or any computer with an Internet connection). In this manner, each user may be presented the same appointments set up in the family calendar regardless of where or how the user accesses the family calendar.

As will be described in a greater detail below, individual work calendar information is filtered to update a family calendar and vice versa. The individual work calendar information is maintained by a work calendar service 120 that provides a calendaring service for employees of an organization. The work calendar service may be any conventional calendar service storing work related appointments for an individual user. The work calendar service 120 may include a database 116 for storing work calendar information and user related information. The method and system also allow a user to mark a work calendar appointment as “Family Appointment” if the work calendar appointment needs to be synchronized to the family calendar. In certain aspects, users can establish a rule that is automatically applied to determine which new appointments are to be marked as a family appointment. In yet another aspect, users can establish a rule to automatically synchronize new work appointments to the family calendar if the new work appointment falls outside of the user's normal working hours.

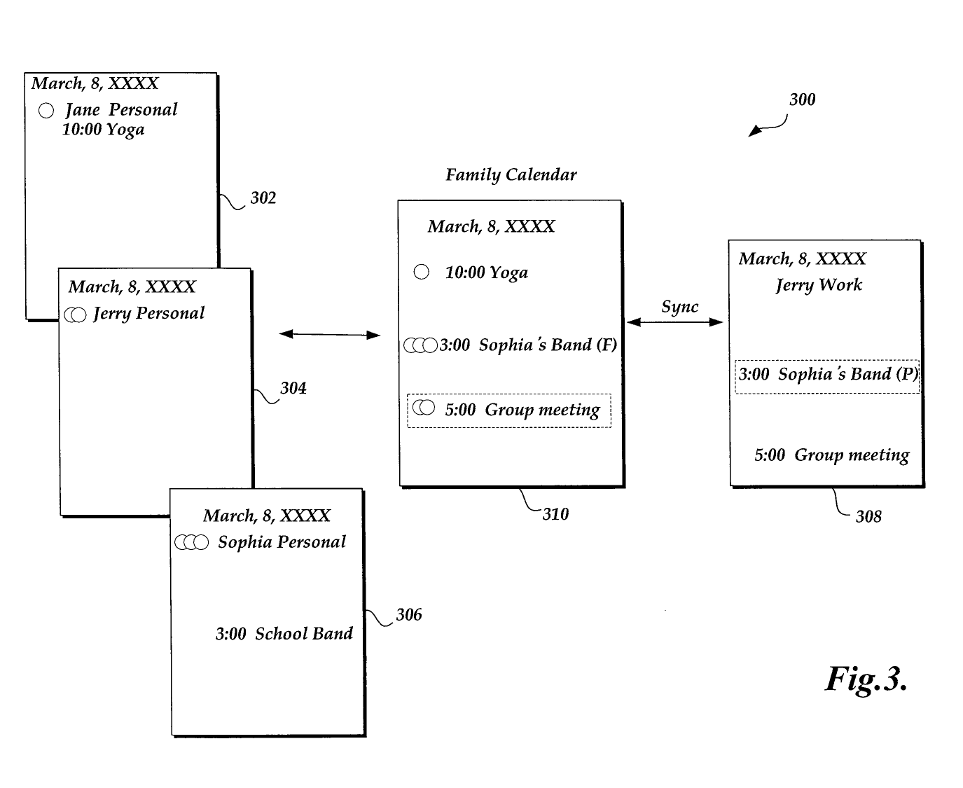

Referring now to FIG. 3, a simple block diagram 300 depicts the relationship between a family calendar 310 and a work calendar 308 of a particular family member. As shown, each member of the family can enter personal appointments with a family calendar service. For example, Jane can enter her “Yoga” appointment at 10:00 AM; Sophia can enter her “school band” appointment at 3:00 PM. The family calendar service will show a family calendar 310 including appointments of the family members. Each appointment is associated with the name of the user who enters the appointment. Such association is generally visualized in the family calendar through using different colors, different icons, etc to represent a user name. Some appointments may be specified for the entire family member. For example, the entire family may need to know about Sophia's “school band” appointment. Sophia may indicate this to the family calendar service server by marking the “school band” appointment as “Family Appointment”.

In some embodiments, the family calendar may be integrated into one or more work calendars of a family member and vice versa. For example, the appointment for the entire family (e.g., marked as “Family Appointment”) will be incorporated into a work calendar of a family member, for example Jerry's work calendar 308. Likewise, a family member's work calendar may also be incorporated into the family calendar. For example, Jerry's work appointment may also be included in the family calendar 310. As will be discussed in a greater detail below, the synchronization process between the family calendar and the work calendar may be controlled by a set of rules and exceptions to the rules.

In one embodiment, users are registered with the family calendar server for receiving a family calendar service. In general, users are recommended to install a synchronization engine (synchronization adaptor, synchronization component) which in turn resides in a user device and assists users to access to the family calendar server. The synchronization engine is configured to perform a synchronization process between the family calendar and the work calendar, although for other environments an alternative synchronization component or adaptor serving a similar purpose could be used as would be apparent to one of ordinary skill in the art. Any functionality, application, module or tools installed locally or remotely can be used as long as they are configured to synchronize two different sets of calendar data based on a set of rules. It is contemplated that two different sets of calendar data can be maintained in many ways. For example, two different sets of calendar data may be maintained within a single calendar service server. In such an example, the synchronization engine may be one component of the calendar service serve in charge of a synchronization process of the two different sets of calendar data.

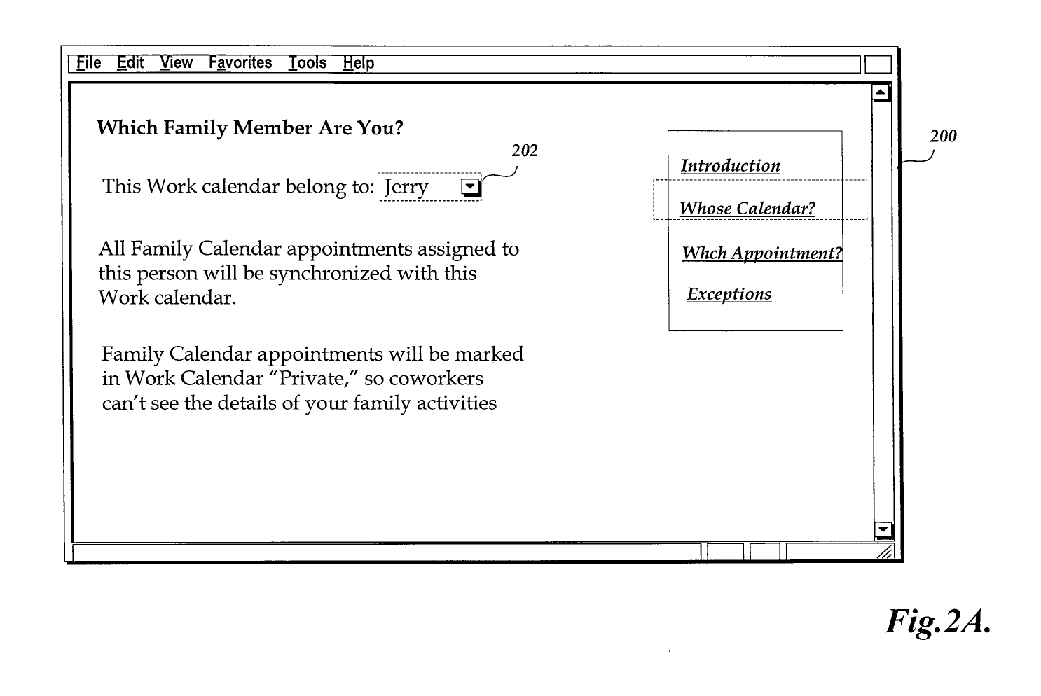

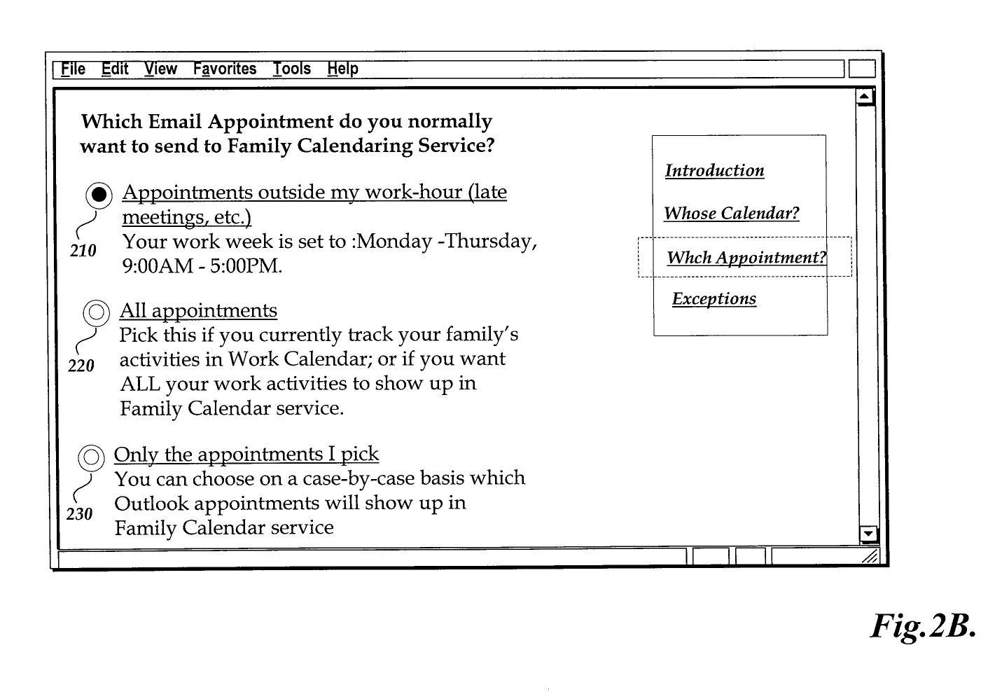

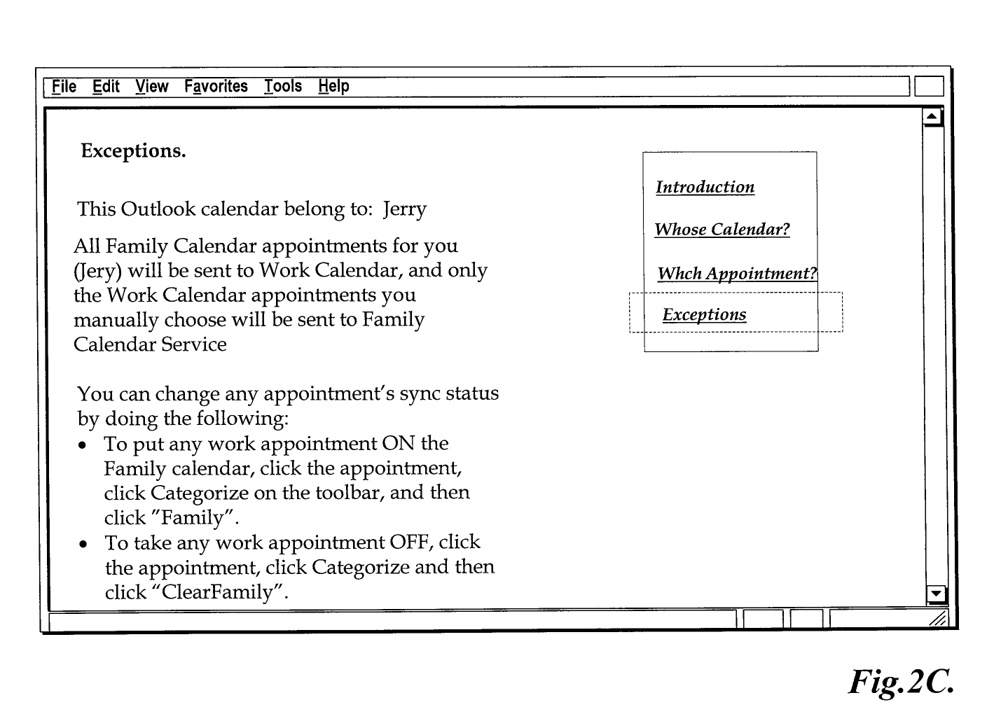

Referring now to FIGS. 2A-2C, several exemplary screen displays showing interactions with the user to obtain information during the registration process are depicted. Referring to FIG. 2A, the family calendar service obtains information about the user's identification. As shown, the family calendar service may retrieve the user information from information stored with the work calendar. The retrieved user information may be presented to the user to verify. As shown in FIG. 2A, the user can be presented with a dropdown list-box selection 202 that, upon selection, lists the names of the family. Alternatively, the user can input the user name. All family calendar appointments associated with the user name will be synchronized (added) to the work calendar. In the family calendar service, the user name will be used to mark appointments with the user name in order to identify who the appointments are associated with. After obtaining the information, the synchronization engine may recognize and remember that the particular work calendar belongs to the user (the user name) and only a subset of family appointments, for example, family appointments associated with the user name, may be considered for a sync process to the particular work calendar.

Referring to FIG. 2B, the family calendar service or the synchronization engine allows the user to set up some rules for controlling the synchronization between the work calendar and the family calendar. As will be well appreciated, there are many ways to set up such rules. Thus, the rule setting process discussed in conjunction with FIG. 2B should be taken as being illustrative in nature, and not limiting to the scope of the disclosure. The family calendar service or the synchronization engine may present a few choices of a basic rule for sending work appointments to the family calendar. The user can select a desired rule during the registration. The selected rule will be applied as a default for the synchronization processing unless the user indicates otherwise. As shown, one choice may be to send appointments outside of the user's work hour to the family calendar, for example a selection menu 210.

In one embodiment, after the user selects this choice, the service may request the user to specify the work-hour. The service or the synchronization engine may obtain and use the work hour specified in the work calendar application. The work-hour may be used to filter some work related appointments that can be overlapping with family activities. If the work related appointments are outside of the work hour, the service or the synchronization engine assumes that family members need to know such work related appointments. Another choice may be to send all appointments to the family calendar, for example a selection menu 220 as shown in FIG. 2B. In some embodiments, when a user has not yet specified any rules for synchronization, the service or synchronization engine may apply a default rule. In one embodiment, the “All” rule, marking all work appointments to be synchronized to a family calendar, may be used as a default rule. As discussed above, the user can always override a default or specified rule. Yet another choice may be to send only appointments that the user manually indicates to synchronize to the family calendar, for example a selection menu 230 as shown in FIG. 2B.

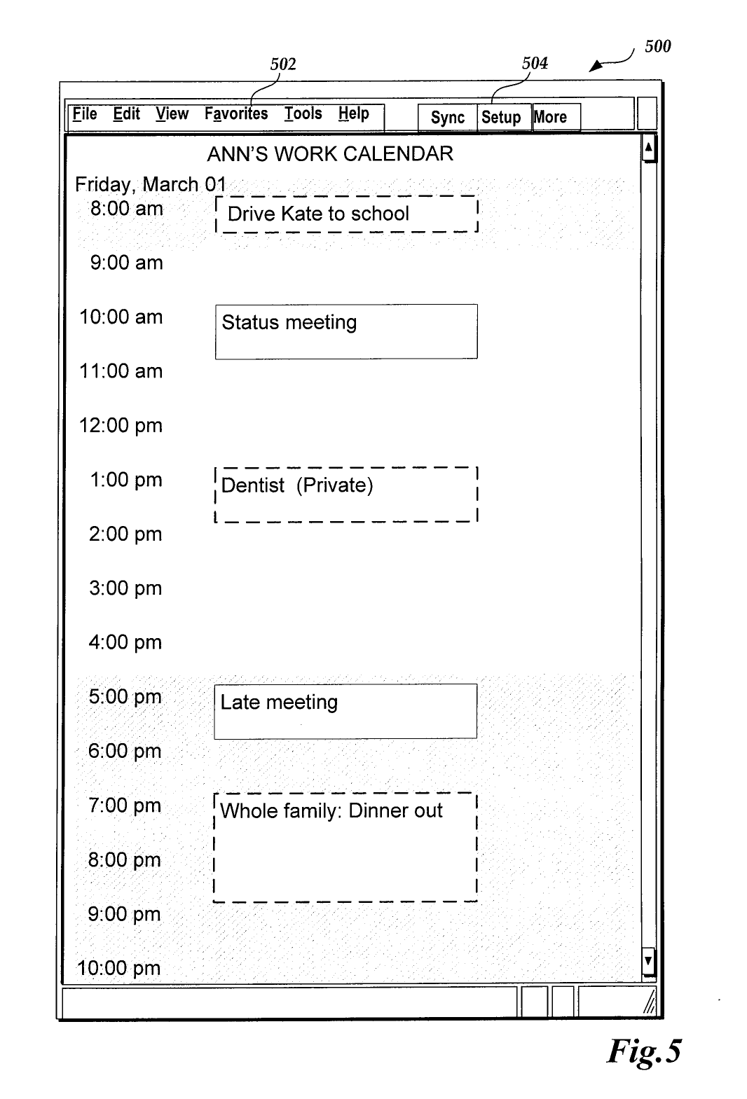

As discussed above, in some embodiments, after the synchronization engine is installed in a user device, a graphic user interface, such as a toolbar, may be displayed in conjunction with a user interface of a work calendar in order to assist users in a uniform manner. In some embodiments, the toolbar that is used for the synchronization engine may become a part of the tool bar of the work calendar application. Referring to FIG. 5, a conventional work calendar application, such as Microsoft® Outlook calendar, provides a calendar display including work calendar menu options such as Microsoft® Outlook menu 502, and a family calendar tool bar menu 504.

In some embodiments, a visual indicator may be used to distinguish the work appointments from the family appointments displayed in the work calendar. As will be well appreciated, the visual indicator can use a highlight, a color, text, icon, etc. For example, each family appointment is marked by a certain color in the work calendar so that the user can easily identify the family appointments from the work related appointments. In some work calendar environments, co-workers may have access to the user's work calendar. It is undesirable if private/confidential contents of family appointments are shared with other co-workers. In such cases, the user can label family appointments as a private or make family appointments password protected. In this manner, co-workers or other people may know the user has a family appointment for a certain time period but cannot view the content of the appointment.

In certain embodiments, the user is allowed to have a flexible synchronization rule by specifying exceptions to the selected or default rule. Referring to FIG. 2C, the user is instructed how to override the selected or default rule. As shown, initially the user has selected a rule to send manually selected work appointments to the family service server and to send all family appointment to the work calendar. In one embodiment, an appointment may be associated with information such as Meta data describing the appointment's status. The information associated with the appointment may be information about an individual user name/entire group, private/public, to be synced or not, need to be deleted, time stamp of modification, etc. In another embodiment, a category tag is used to override the default or selected rule. For example, the user can attach a “Family Appointment” tag to a work appointment in order to add the work appointment into the family calendar or the synchronization engine attaches a “Family Appointment” tag to a work appointment in accordance with the synchronization rule. The user can remove or change a tag from a work appointment to prevent the appointment to be synced to the family calendar. For example, in order to take any work appointment off from the family calendar, the user can remove “Family Appointment” tag from the work appointment.

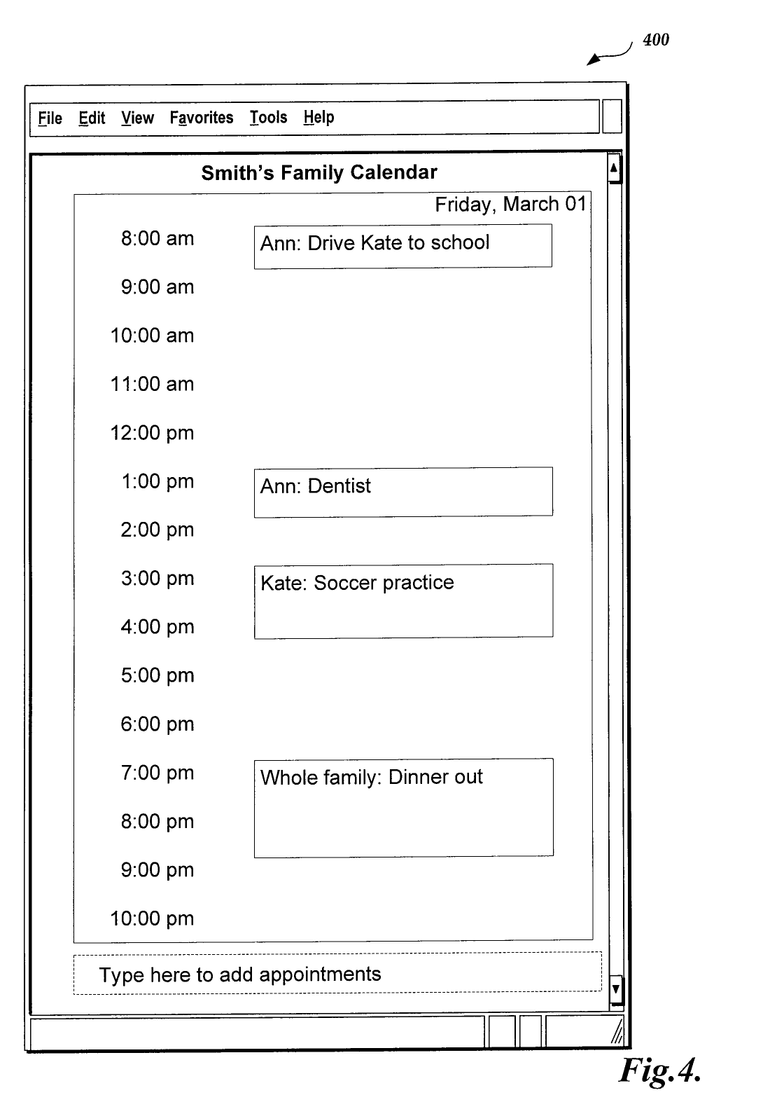

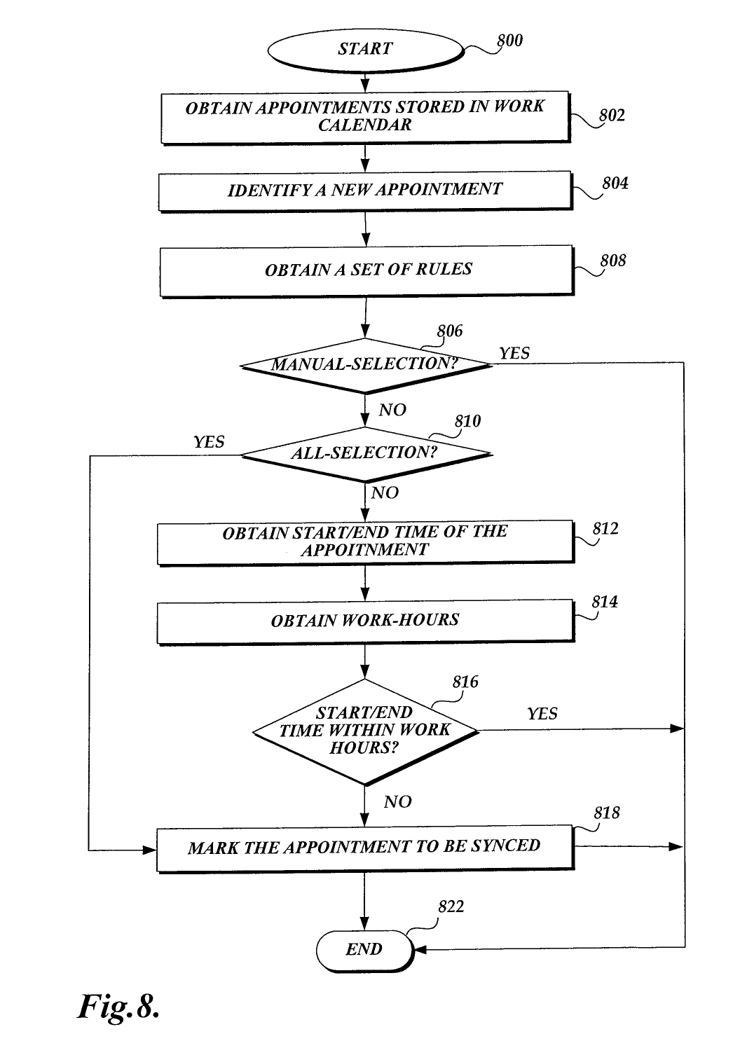

Referring to FIG. 8, a flowchart 800 depicts a method of synchronizing a work calendar of one family member with a family calendar in accordance with an embodiment. For the sake of discussion, it is assumed that a user starts the synchronization engine, or is logged in onto the family calendar service with a proper user account and password. Upon the user's request, a family calendar that belongs to a family of the user may be uploaded and presented to the user for viewing. A family calendar includes appointments that belong to each family member or to the entire family, or some of the family members. As mentioned above, each family member can have a visual indicator, for example an assigned color, to display his/her appointment graphically distinctive. Alternatively, a text such as a user's name may be displayed next to the appointment. Referring now to FIG. 4, an exemplary screen display when the family calendar is presented to the user is depicted. In other embodiments, each family member can have an individual icon, or a graphic identifier to indicate which appointment belongs to which family member.

Most work calendars typically allow a user to define his/her normal working hours. In certain aspect, the synchronization engine may retrieve the normal working hours that have been already stored with a work calendar. For example, such information may be used to establish a default rule for a synchronization process between the family calendar and the work calendar. When this rule is employed, if a new appointment on the work calendar extends beyond the user's normal working hours (e.g., the appointment represents a late work meeting, or an extended business trip), the appointment will be automatically marked (tagged) for synchronization by default. In one aspect, the user can still override the default tagging to indicate that an appointment needs not to be synced to the family calendar. In one embodiment, such rules are stored as part of user profile information with the synchronization engine in the user device. The synchronization engine may present a list of the names of family members so that the user can select the user's name from the list. In certain embodiments, the synchronization engine may be a component of the web-based family calendar service.

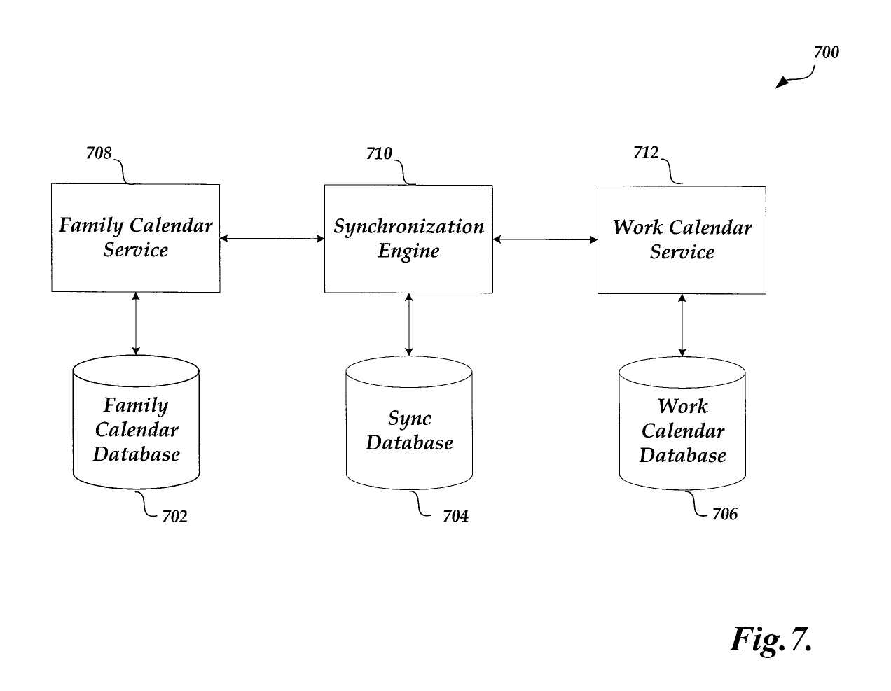

Beginning with block 802, the synchronization engine may obtain appointments stored within a work calendar of a user. In certain embodiments, the synchronization engine may be installed on a user device where the user usually reads and checks work related emails or calendar information. The synchronization engine may operate in conjunction with any work calendar application, for example Microsoft® Office Outlook. In one embodiment, the synchronization engine maintains copies of the family calendar and the work calendar in local memory. Referring now to FIG. 7, a simple block diagram of a synchronization engine that maintains copies of a family calendar and a work calendar of a user is depicted. The copy of the work calendar maintained by the synchronization engine is a mirror-copy of the work related appointments stored in a work calendar service provider. Likewise, the copy of the family calendar maintained by the synchronization engine is a mirror copy of the family appointment stored in the family calendar service server. The synchronization engine is constantly communicating with the family calendar and the work calendar. However, it will be appreciated by those of ordinary skill in the art such a synchronization engine could operate equally well without maintaining mirror copies of the work calendar and the family calendar. Thus, the operations of the synchronization engine described above should be taken as being illustrative in nature, and not limiting to the scope of the disclosure. Referring back to FIG. 8, at block 804, the synchronization engine identifies newly added appointments. For example, the synchronization engine may compare family calendar information related to the user and the work related calendar information to identify newly added appointments.

At decision block 806, it is determined as to whether the user has a default rule indicating to enter new appointments manually to the family calendar. If not, it is determined at decision block 810 as to whether the user indicates to synchronize all of the new appointments to the family calendar. If it is determined that the user does not indicate to synchronize all of the new appointments, the synchronization engine may compare appointments with the work-hour of the user. The synchronization engine obtains a start and end time specified in the new appointment at block 812. The synchronization engine also obtains a work-hour defined for the user. As a default, the work-hours may be 9:00 AM-5:00 PM for weekdays. The user can specify a different work-hour suitable for the user's schedule through interactions with the synchronization engine. Subsequently, the user profile information is updated to reflect the change of the work-hour. At decision block 816, it is determined as to whether the start time and the end time of the new appointment lie within the obtained work-hour. If it is determined at decision block 816 that the start time or the end time of the new appointment do not lie within the obtained work-hours, or if it is determined at decision block 810 that the user indicates to sync all of the new appointments, the synchronization engine marks the new appointment to be synchronized with the family calendar as illustrated in block 818. After the marking the new appointment to be synchronized (block 818) or if it is determined that the user indicates to enter the new appointment to the family calendar manually (block 806), the routine stops at block 822. As will be well appreciated, the routine may repeat the above mentioned steps for each identified new appointment. The synchronization engine will communicate with the family calendar service server to update the family calendar with the new appointments that are marked to be synchronized.

It is noted that although the flowchart 800 discusses mainly new appointments, one of ordinary skill in the art would understand that any updated appointments including modified and deleted appointments can be handled in a similar manner to the new appointments. For example, if the synchronization engine detects an appointment that has been modified after the appointment was synchronized to the family calendar, the family calendar will be updated accordingly. Likewise, if the synchronization engine detects an appointment that has been deleted after the appointment was synchronized to the family calendar, the appointment will be deleted for the user from the family calendar. If the appointment is also associated with other users in the family calendar, the user's name will be removed from the appointment to reflect the deletion.

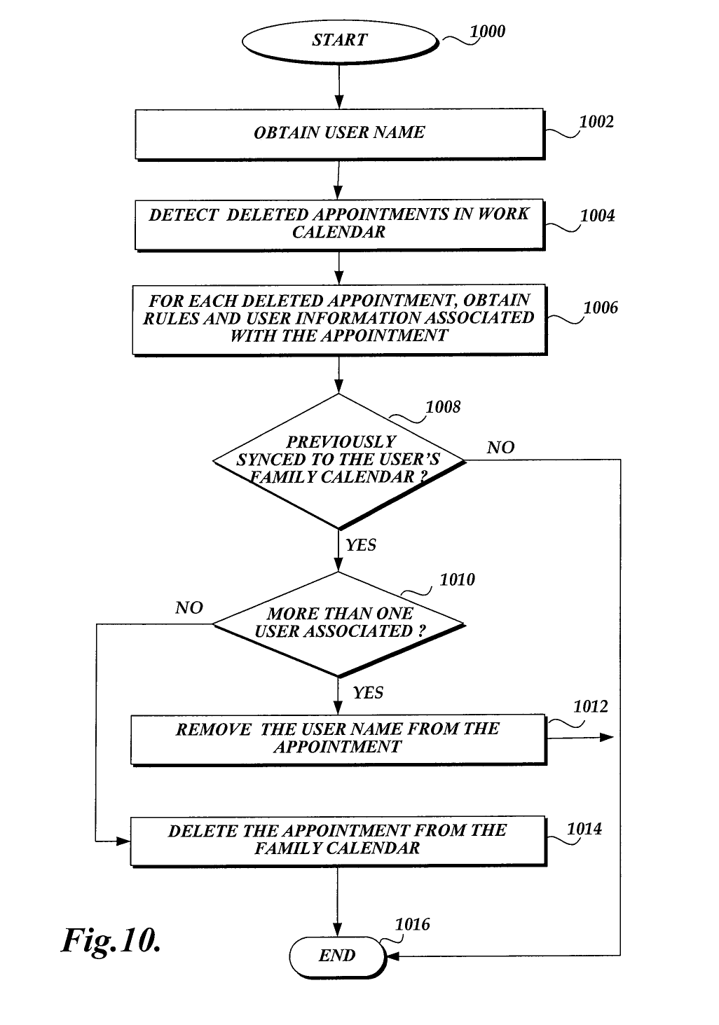

FIG. 10 is a flowchart depicting a method of synchronizing deleted work appointments of one family member to a family calendar in accordance with an embodiment. Beginning with block 1002, the synchronization engine may obtain a user's name. At block 1004, the synchronization engine detects deleted appointments from the work calendar. At block 1006, for each deleted appointment, the server obtains rules and user information associated with the appointment.

At decision block 1008, it is determined whether the deleted appointment was previously synchronized to the family calendar. If it is determined that the deleted appointment was previously synchronized, at decision block 1010, it is determined as to whether the appointment is associated with more than one user. In some instances, an appointment may be associated with several users after being synchronized to the family calendar. As discussed above, in the family calendar, an appointment may be associated with the user, all the users (e.g., group appointment), only with some other users, or the like.

If the appointment is associated with several users' names, the server removes the user's name from the appointment that corresponds to the deleted appointment at block 1012. If it is determined that the deleted appointment is associated only with the user name, the appointment will be deleted from the family calendar 1014. If the deleted appointment was not previously synchronized or after the user name is removed or the appointment is removed, the routine will complete at block 1016. As with FIG. 8, the routine repeats the above mentioned steps until all deleted appointment is handled.

In one embodiment, family calendar information is also filtered in order to update an individual work calendar. In one embodiment, a group or family calendar information is filtered in order to update an individual work calendar so that family appointment can be shown in the work calendar of the user. The method and system allow a user to mark a family calendar appointment with several user names to indicate that that family calendar appointment is associated with the several users in the group. Family appointments associated with a name of a particular user will be synced to a work calendar of the particular user. Additionally, some appointments can be marked for the entire group (e.g., entire family, etc), indicating that such appointments are associated with each member of the group. Such family appointments marked for the entire group are also synced to the work calendar of the user.

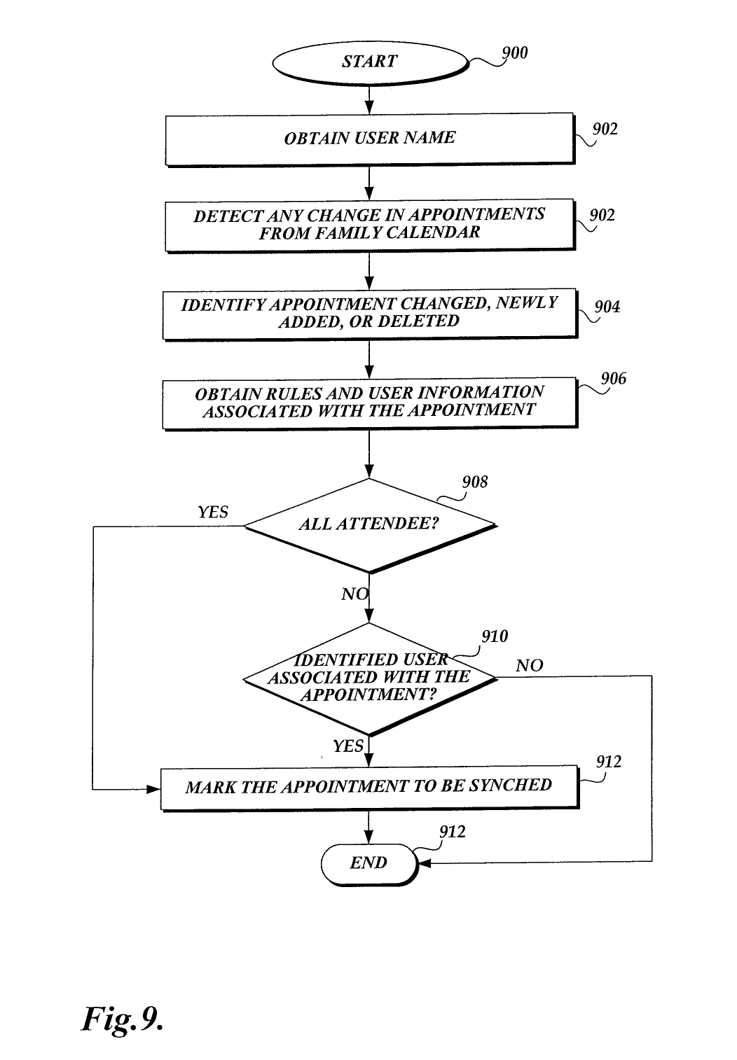

Referring to FIG. 9, a flowchart depicts a method of synchronizing the family calendar with a work calendar of one family member in accordance with an embodiment of the present invention. As with FIG. 2, it is assumed that a user has registered with the server and selected a user name. In one embodiment, once the synchronization engine is installed, the synchronization engine is running background as the user starts the user device. In such embodiment, the synchronization engine periodically performs a synchronization process. The synchronization may utilize the user profile information locally stored for the user work calendar. In some embodiments, the family calendar that belongs to a family of the user may be uploaded and presented to the user for viewing. The user may select the user's name from the list of names of the family members. The synchronization engine starts the synchronization process to the user's work calendar only with those appointments on the family calendar which that particular user needs to attend or is responsible for. That is, appointments associated with the user name or marked for all family members (e.g., marked as “Whole Family”) may be synchronized to a work calendar of the user.

Beginning with block 902, the synchronization engine may obtain a user's name from the work calendar, the local data base storing the user profile information, or the user. In some embodiments, the user may be requested to select the user's name from the list of names of family members. At block 902, the synchronization engine detects any changes in appointments stored in the family calendar. The synchronization engine identifies each appointment that is changed newly added, or deleted since the last synchronization process for the particular user at block 904. The synchronization engine may obtain rules and user information associated with the identified appointment.

At decision block 908, it is determined as to whether the appointment marked for the entire family. If it is determined for the entire family, the appointment is marked to be synchronized to the work calendar. If it is determined at decision block 908 that the appointment is for an individual user, it is further determined at decision block 910 as to whether the appointment is associated with the user's name. If it is determined that the appointment is associated with the user, the appointment is marked to be synchronized to the work calendar. The routine will terminate at block 912. As will be well appreciated, the routine may repeat the above mentioned steps for each identified appointment.

In some instances, an appointment was initially associated with several users but a particular user's name has been removed because the particular user does not want the appointment shown his/her work calendar. Such an appointment is also handled as a deleted appointment with respect to the particular user. For example, an appointment may be associated with the user, all the users (e.g., group appointment), only with some other users, or the like. As with the newly added appointments, deleted appointments associated with the user or all the users may be handled for synchronizing to a work calendar of the user. If the deleted appointment was previously synchronized, the server deletes the user's work appointment that corresponds to the deleted appointment.

Referring to FIGS. 4, 5, and 6 an exemplary screen displays depicting synchronization process between a family calendar and a work calendar in accordance with an embodiment. In FIGS. 4 and 5, the “Family Calendar” 400 and “Work Calendar” 500 show a typical day as it might appear in a family and work calendar. It is assumed that a family includes a working mother, Ann, and her daughter Kate. It is also assumed that Ann works from 9:00 am to 5:00 pm and thus, she specified her work-hour with 9:00 am to 5:00 pm. As shown in FIG. 4, “Ann” and “Kate” each inputs personal appointments with the family calendar service. For example, “Ann” inputs “Drive Kate to School at 8:00 AM,” and “Dentist at 1:00 PM” that are associated with her name. Ann also inputs “Dinner out at 7:00 PM” and marks the appointment as “Whole Family.” Kate also inputs “Soccer Practice at 3:00 PM” that is associated with her name. For Ann's work calendar, the synchronization engine detects changes in appointments stored in the Family Calendar 400. The synchronization engine identifies each appointment that is changed and newly added. New appointments “Drive Kate to School at 8:00 AM” and “Dentist at 1:00 PM” are associated with Ann. New appointment “Dinner out at 7:00 PM” is marked as “Whole Family.” The work calendar 500 is updated with the new appointments and “Drive Kate to School at 8:00 AM,” “Dentist at 1:00 PM,” and “Dinner out at 7:00 PM” are shown in the work calendar of Ann. Another new appointment “Soccer Practice at 3:00 PM” is not synchronized to Ann's work calendar because the appointment is associated with Kate. “Dentist at 1:00 PM” may be marked as “private” so that co-workers cannot view the content of the appointment.

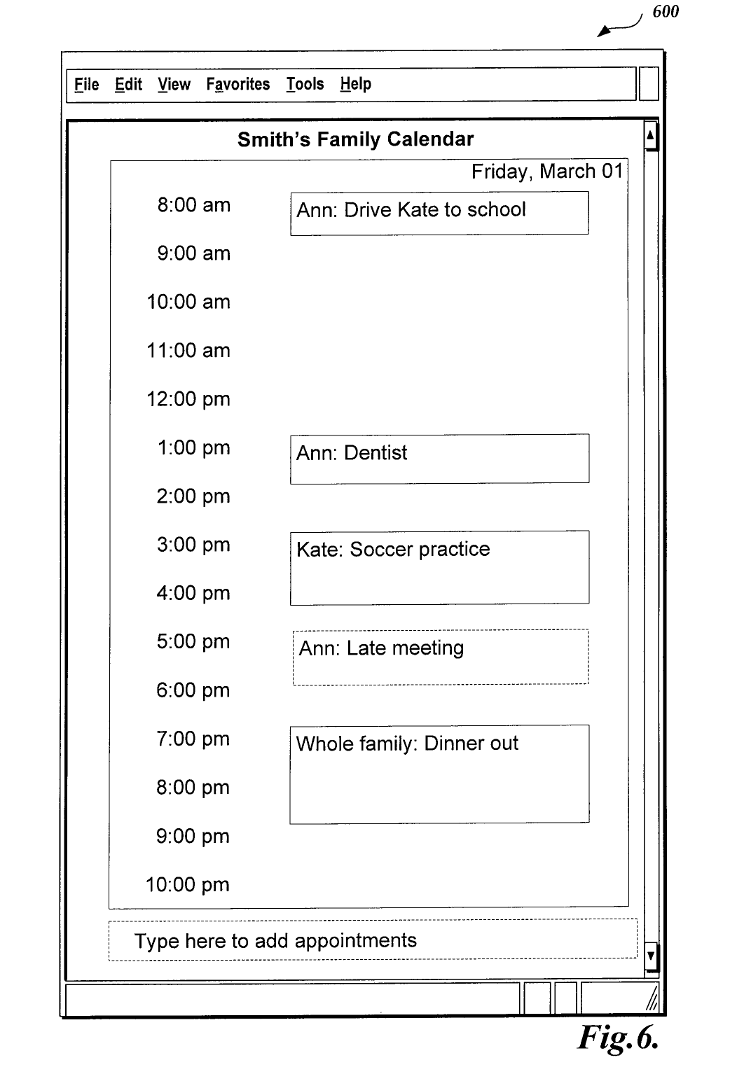

As shown in FIG. 5, Ann also inputs her work appointments, such as “Status meeting at 10:00 AM” and “Late meeting at 5:00 PM” to her work calendar. Assume that Ann specified her synchronization rule to use the work-hour to filter work appointments. For example, with reference to FIG. 2B, a selection rule 210 is selected. The synchronization engine detects changes in appointments stored in the Work Calendar 500. Among new appointments, “Late meeting at 5:00 PM” has 5:00 PM start time and 6:00 PM end time. The end time of the appointment “Late meeting at 5:00 PM” falls outside of the work-hour of Ann. The family calendar is updated with “Late meeting at 5:00 PM”. However, the family calendar is not updated with the appointment “Status meeting” because it starts at 10:00 AM and ends at 1:00 AM which lies within the work-hour of Ann. Referring now to FIG. 6, the family calendar 600 includes “Late meeting at 5:00 PM” that is associated with Ann.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracles, Microsoft®, Sybase®, and IBM®.

The environment can include a variety of data base and other memory and storage media as discussed above. These can reside in a variety of locations, such as on a storage medium local to (and/or resident in) one or more of the computers are remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for synchronizing a first calendar with a second calendar, wherein the first calendar is shared by a group of users and the second calendar is a work calendar of a user, the method comprising:
obtaining appointments stored with the second calendar;
obtaining a set of conditions for a synchronization process of the second calendar;
identifying, from the obtained appointments, appointments that have been newly added, updated, or deleted;
filtering the identified appointments based on the set of conditions; and
updating the first calendar based on the result of filtering,
wherein the user is a member of the group of users.

2. The method of claim 1, wherein filtering the identified appointments includes:
for each identified appointment:
checking information associated with the identified appointment;
comparing the information with the set of conditions; and
if the information satisfies the set of conditions, marking the identified appointment to be synchronized.

3. The method of claim 2, wherein updating includes updating the first calendar with the appointments marked to be synchronized.

4. The method of claim 3, wherein if the appointments marked to be synchronized are newly added appointments to the second calendar, the appointments are added to the first calendar.

5. The method of claim 3, further comprising: if the appointments marked to be synchronized are modified appointments in the second calendar,
identifying appointments stored in the first calendar corresponding to the modified appointments, and
modifying the identified appointment in the first calendar.

6. The method of claim 3, further comprising: if the appointments marked to be synchronized are deleted appointments from the second calendar,
identifying an appointment stored in the first calendar that corresponds to the deleted appointment, and
deleting the identified appointment from the first calendar.

7. The method of claim 2, wherein the set of conditions include a condition specifying work-hours for the user.

8. The method of claim 7, further comprising if a start time or an end time of the identified appointment falls outside of the work-hours, marking the appointment to be synchronized.

9. The method of claim 2, wherein the set of conditions include a condition specifying a manual synchronization.

10. The method of claim 1, wherein each user of the group is enable to enter appointments for the user to the first calendar via a network, the appointments being associated with the user's name.

11. The method of claim 1, wherein each user of the group is enable to enter appointments for the entire group to the first calendar via a network, the appointments being associated with the entire group.

12. The method of claim 1, wherein each user of the group is enable to enter appointments for one or more users to the first calendar via a network, the appointments being associated with names of the one or more users.

13. The method of claim 6, wherein deleting includes removing the user name from the appointment if the appointment is also associated with another user's name.

14. The method of claim 1, wherein the first calendar is a family calendar and the second calendar is a work calendar of the user.

15. A method for synchronizing a first calendar with a second calendar, wherein the first calendar is a work calendar of a user and the second calendar is shared by a group of users, the method comprising:
obtaining a user identification and a set of rules defined for the user in the second calendar;
obtaining appointments stored with the second calendar;
detecting changes in the obtained appointments;
upon detecting the changes, identifying appointments that are to be synchronized to the first calendar based on the set of rules; and
updating the first calendar with the identified appointments.

16. The method of claim 15, wherein the set of rules include a rule indicating that an appointment associated with the user's name is to be synchronized to the first calendar.

17. The method of claim 15, wherein the set of rules includes a rule indicating that an appointment associated with the group is to be synchronized to the second calendar.

18. The method of claim 15, wherein if the user's name is removed from the appointments, the appointment is treated as a deleted appointment for the second calendar of the user.

19. The method of claim 15, wherein the user is enabled to mark an appointment as a private appointment so that after synchronization of the appointment, the content of the appointment is hidden from other users.

20. The method of claim 15, further comprising:
upon detecting the changes, determining deleted appointments from the second calendar; and
for each deleted appointment, if the deleted appointment has been synchronized to the first calendar,
identifying an appointment stored in the first calendar that corresponds to the deleted appointment; and
deleting the identified appointment from the first calendar.

21. The method of claim 15, further comprising:
upon detecting the changes, determining modified appointments from the second calendar; and
for each modified appointment, if the modified appointment has been synchronized to the first calendar of the user, updating an appointment stored in the first calendar that corresponds to the modified appointment.

22. A system for synchronizing a first calendar with a second calendar, wherein the first calendar is a work calendar of a user and the second calendar is shared by a family of the user, the system comprising:
a memory for storing user profile information and a set of synchronization rules defined for the user:
a synchronization engine operable to:
obtain a user identification and the set of synchronization rules regarding the second calendar;
obtain work appointments stored with the second calendar;
detect changes in the obtained work appointments;
upon detecting the changes, identify work appointments that are to be synchronized to the first calendar based on the set of rules; and
update the first calendar with the identified work appointments.

23. The system of claim 22, wherein the synchronization engine is further operable to:
upon detecting the changes, identify a deleted work appointment from the second calendar; and
if the deleted work appointment has been synchronized to the first calendar, delete a family appointment stored in the first calendar that corresponds to the deleted work appointment.

24. The system of claim 22, wherein the synchronization engine is further operable to:
upon detecting the changes, identify a new work appointment from the second calendar; and
if a start time or an end time of the new work appointment falls outside of work-hours, add a family appointment that corresponds to the new work appointment to the first calendar.

25. The system of claim 22, wherein the work-hours were predefined in the user profile information.

26. A system for synchronizing a first calendar with a second calendar, wherein the first calendar is shared by a group of users and the second calendar is a work calendar of a user, the system comprising:
a memory for storing a set of rules specified for a synchronization process of the second calendar and information about the user;
a synchronization adaptor operable to:
obtain the set of conditions from the memory;
identify, from the second calendar, work appointments that have been newly added, updated, or deleted;
filter the identified work appointments based on the set of conditions; and
update the first calendar based on the result of filtering.

27. The system of claim 26, wherein the synchronization adaptor is operable to:
for each identified appointment:
check tag information associated with the identified appointment;
compare the tag information with the set of conditions; and
if the tag information satisfies the set of conditions, mark the identified work appointment to be synchronized.

28. The system of claim 26, wherein the work appointments marked to be synchronized is incorporated into the first calendar.

29. The system of claim 26, wherein the set of conditions include a condition specifying work-hours for the user.

30. The system of claim 26, wherein, if a start time or an end time of the identified appointment falls outside of the work-hours, the appointment is marked to be synchronized.
